(19) United States
(12) Patent Application Publication
(10) Pub. No.: US 2026/0306953 A1
(43) Pub. Date: Oct. 8, 2026

(54) GAME DEVICE

(71) Applicant: TOMY COMPANY, LTD., TOKYO (JP)

(72) Inventor: Junpei HIGASHI, TOKYO (JP)

(73) Assignee: TOMY COMPANY, LTD., TOKYO (JP)

(21) Appl. No.: 19/482,726

(22) PCT Filed: May 13, 2024
(86) PCT No.: PCT/JP2024/017647

§ 371 Date: Nov. 7, 2025

(30) Foreign Application Priority Data
May 15, 2023 (JP) 2023-080009

(51) Int. Cl. A63F 13/65; A63F 9/16; A63F 13/52; G06T 7/246; G06T 7/73; G06V 20/50; G09G 3/00

(52) U.S. Cl. CPC A63F 13/65; A63F 9/16; A63F 13/52; G06T 7/248; G06T 7/74; G06V 20/50; G09G 3/001; G06T 2207/30204

(57) ABSTRACT

A game device includes a field on which a toy top moves while spinning, a display means being configured to display a first image on the field, a capturing means being configured to capture motion of the toy top present on the field, and a control means being configured to control the display means and the capturing means. The control means is configured to detect a motion state of the top toy including a current position, a movement state, and a rotation state of the toy top, based on information from the capturing means. The first image includes a second image. The control means is configured to display the first image on the field corresponding to the motion of the toy top and to modify the first image according to the motion state. The control means is configured to display the second image indicating a current position of the toy top on the field.

### CROSS-REFERENCE TO RELATED APPLICATION

This is National Phase Patent Application of International Application No. PCT/JP 2024/017647 filed on May 13, 2024, which claims foreign priority to Japanese Patent Application No. 2023-08009 filed on May 15, 2023. The entire content of Japanese Patent Application No. 2023-08009 is incorporated herein by reference.

### BACKGROUND

### Technical Field

The present disclosure relates to a game device.

Conventionally, there is known a game device that is capable of detecting a position of a moving object placed on a field and projecting an image onto the moving object (see PTL 1, for example).

### Patent Literature

PTL 1: Japanese Patent Application Publication No. 2012-24167

### SUMMARY

### Technical Problem

However, in the game device described in PTL 1, images such as numerical values are projected onto the moving object itself, so the design of the moving object needs to be made not to impede the visibility of the projected image, which reduces the degree of freedom in the design of the moving object and fails to sufficiently enhance the enjoyment of games using the moving object.

Furthermore, in the game device described in PTL 1, the motion of the moving object is extremely slow, allowing players to easily follow its movement, but when a toy top is used as the moving object, it moves at high speed and also moves randomly and collides with other toy tops, making it difficult for players to follow its motion and failing to sufficiently enhance the enjoyment of games using moving objects.

### Means for Solving the Problem

An object of the present disclosure is to increase enjoyment of playing with a toy top.

A game device includes a field on which a toy top moves while spinning, a display means being configured to display an first image on the field, a capturing means being configured to capture motion of the toy top present on the field, and a control means being configured to control the display means and the capturing means. The control means is configured to detect a motion state of the top toy including a current position, a movement state, and a rotation state of the toy top, based on information from the capturing means. The first image includes a second image. The control means is configured to display the first image on the field corresponding to the motion of the toy top and to modify the first image according to the motion state. The control means is configured to display the second image indicating a current position of the toy top on the field.

### BRIEF DESCRIPTION OF DRAWINGS

FIG. 1 is a perspective view of a game device.

FIG. 2 is a side view of the game device.

FIG. 3 is a top view of the game device.

FIG. 4 is a block diagram illustrating an example of a configuration of a control system.

FIG. 5 is a top view of a stadium.

FIG. 6 is a top view of a first component member.

FIG. 7 is an exploded perspective view of the stadium.

FIG. 8A is a perspective view of a toy top and illustrates an identification marker.

FIG. 8B is a diagram illustrating an identification marker.

FIG. 8C is a diagram illustrating an identification marker.

FIG. 8D is a diagram illustrating an identification marker.

FIG. 8E is a diagram illustrating an identification marker.

FIG. 8F is a diagram illustrating an identification marker.

FIG. 9A is a diagram explaining a method for detecting a motion state of the toy top.

FIG. 9B is a diagram explaining a method for detecting the motion state of the toy top.

FIG. 9C is a diagram explaining a method for detecting the motion state of the toy top.

FIG. 10A is a diagram explaining a display on a field.

FIG. 10B is a diagram explaining a display on the field.

FIG. 10C is a diagram explaining a display on the field.

FIG. 10D is a diagram explaining a display on the field.

FIG. 11 is a diagram explaining a flow of a game.

FIG. 12A is a diagram explaining a display on a touch panel display.

FIG. 12B is a diagram explaining a display on the field.

FIG. 12C is a diagram explaining a display on the field.

FIG. 12D is a diagram explaining a display on the field.

FIG. 12E is a diagram explaining a display on the field.

FIG. 12F is a diagram explaining a display on the field.

FIG. 12G is a diagram explaining a display on the field.

FIG. 12H is a diagram explaining a display on the field.

FIG. 12I is a diagram explaining a display on the field.

FIG. 12J is a diagram explaining a display on the field.

FIG. 13A is a diagram explaining a display on the field.

FIG. 13B is a diagram explaining a display on the field.

FIG. 13C is a diagram explaining a display on the field.

FIG. 13D is a diagram explaining a display on the field.

FIG. 13E is a diagram explaining a display on the field.

FIG. 13F is a diagram explaining a display on the field.

FIG. 13G is a diagram explaining a display on the field.

FIG. 13H is a diagram explaining a display on the field.

FIG. 13I is a diagram explaining a display on the field.

FIG. 13J is a diagram explaining a display on the field.

FIG. 14 is a block diagram illustrating an example of a configuration of a control system according to a first modification.

FIG. 15 is a diagram illustrating a flow of a game according to the first modification.

FIG. 16 is a diagram illustrating reward given to players according to the first modification.

### DETAILED DESCRIPTION OF THE PREFERRED EMBODIMENTS

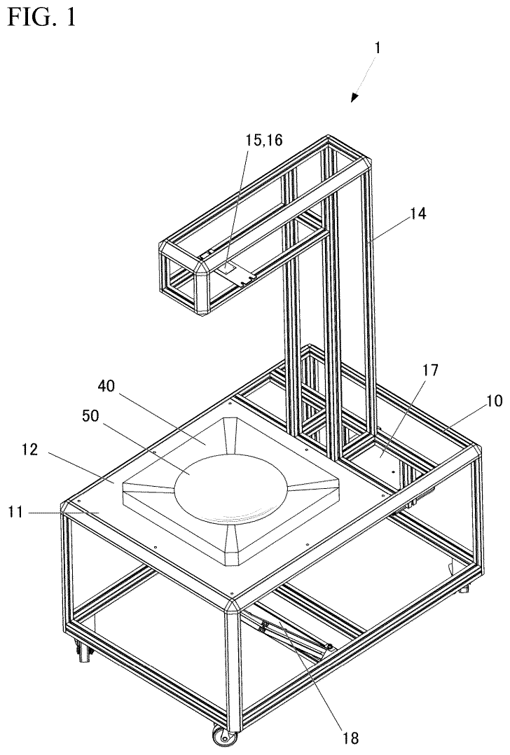

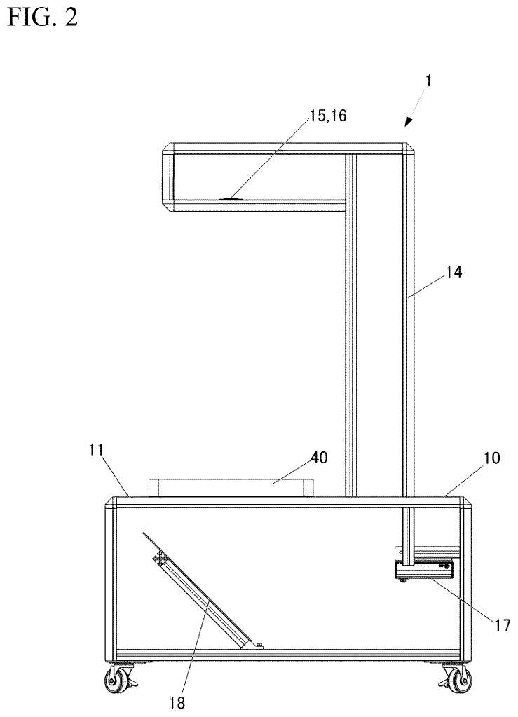

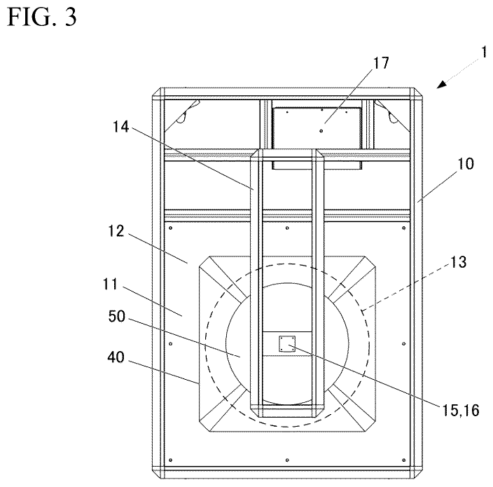

Hereinafter, an embodiment of the present disclosure will be described with reference to the drawings. FIGS. 1 to 3 illustrate an example of a configuration of a game device 1. The game device 1 includes a stadium 40 including a field 50 on which a toy top 80, which is a moving object, can move, and is capable of displaying images on the field 50 and the like according to a motion state of the toy top 80.

The game device 1 has a rectangular box-shaped housing 10 to which various components are attached, and an installation section 11 is provided on a front part of a top surface of the housing 10, and the stadium 40 is installed in the installation section 11.

In the installation section 11, a support plate 12 made of a transparent material is provided so as to be approximately horizontal, and the stadium 40 is installed on the support plate 12 so that the center of the installation section 11 coincides with the center of the field 50. Note that the installation section 11 may be provided with a guide unit for guiding the installation position and installation direction of the stadium 40, so that the stadium 40 is installed in a specified position and direction relative to the installation section 11.

At the central portion of the support plate 12, a circular opening 13 is formed and since the circular opening 13 overlaps with the field 50, an image can be projected onto the field 50 without passing through the support plate 12, and the image can be clearly projected onto the field 50.

At a rear portion of the housing 10 and behind the installation section 11, a support pillar 14 is provided which extends above the housing 10 and also extends forward so as to overlap the stadium 40 vertically. On a lower surface of a forward extending portion of the support pillar 14, which is located above the stadium 40, a camera 15 and a light source 16 are provided facing the stadium 40.

The camera 15 is disposed at a position vertically overlapping with the center of the installation section 11, and the light source 16 is disposed so as to surround the camera 15. With this configuration, the camera 15 can capture an image of the toy top 80 moving on the field 50.

According to the present embodiment, the camera 15 is an infrared camera, and the light source 16 is capable of emitting infrared light.

Inside the housing 10, a projection device 17 for projecting an image and a mirror 18 for reflecting the image projected from the projection device 17 toward the installation section 11 are provided.

The projection device 17 is provided at a position behind the installation section 11 and at a position lower than the installation section 11. A lens portion that projects the image is aligned with the center of the installation section 11 along the front-rear direction, and is disposed so as to project the image substantially horizontally forward along the front-rear direction.

The mirror 18 is provided at a position below the installation section 11 and is arranged obliquely so as to reflect the image projected substantially horizontally forward from the projection device 17 vertically upward toward the installation section 11. With this configuration, the image is projected onto the bottom surface of the stadium 40.

Although not illustrated in FIGS. 1 to 3, an outer surface constituent member that constitutes the outer surface of the game device 1 is provided around the housing 10 and the support pillar 14. With this configuration, the housing 10 and the support pillar 14 are covered and the inside cannot be seen.

This exterior component can decorate the game device 1 and also prevent external light from entering the underside of the field 50, improving the visibility of the images projected onto the field 50.

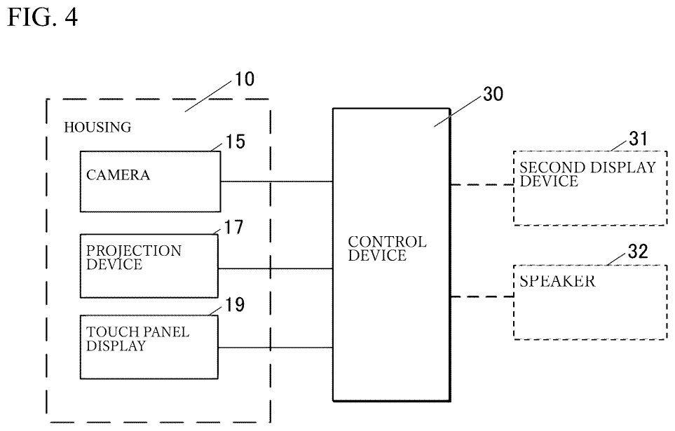

FIG. 4 is a block diagram illustrating a control system of the game device 1.

The game device 1 is provided with a control device 30 that controls the game device 1. The control device 30 may be provided separately from the housing 10 or may be provided inside the housing 10.

The control device 30 receives information from the camera 15, generates an image based on the input information, and projects the image from the projection device 17.

The game device 1 also includes a touch panel display 19, which is not illustrated in FIGS. 1 to 3, and, on the touch panel display 19, players can input information and information related to games can be displayed.

A second display device 31 and a speaker 32 may also be provided to the housing 10 of the game device 1, and the control device 30 may control the second display device 31 and the speaker 32 to output information related to the games.

Furthermore, the second display device 31 and the speaker 32 may be provided outside the game device 1, and the control device 30 may control the second display device 31 and the speaker 32 to configure a game system that outputs information related to the game.

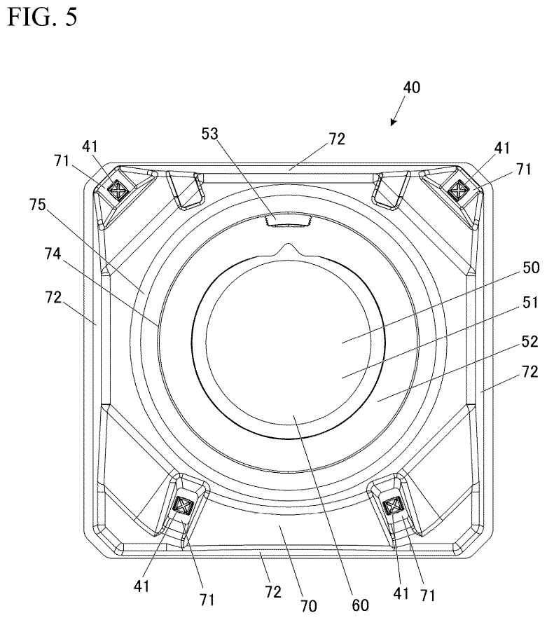

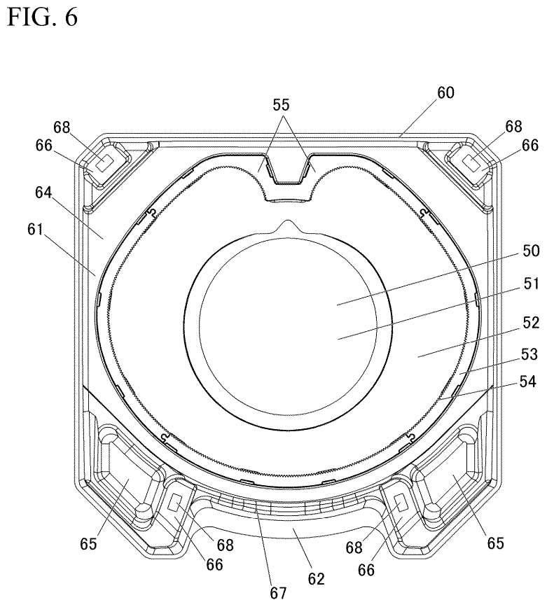

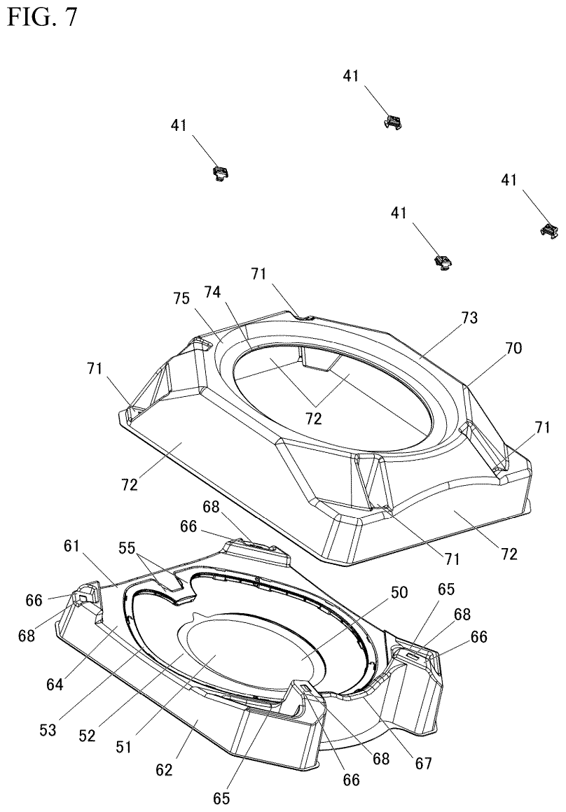

As illustrated in FIGS. 5 to 7, the stadium 40 includes a first component member 60 on which the field 50 is formed, and a second component member 70 arranged to cover the first component member 60.

The first component member 60 includes the substantially circular field 50, an outer edge portion 61 surrounding the field 50, and a side surface portion 62 that forms a side surface and a bottom end of the first component member 60.

The field 50 has a central portion 51, an inclined portion 52 surrounding the outside of the central portion 51, and a rack rail 53 surrounding the outside of the inclined portion 52.

The central portion 51 has a substantially circular shape and is formed to have an inclined surface that slopes in a bowl shape with the center being the lowest.

The inclined portion 52 is inclined downward toward the central portion 51 and has an inclined surface that is steeper than the inclined surface of the central portion 51.

The rack rail 53 is provided with a rack gear 54 that protrudes substantially horizontally toward the center of the field 50. The rack gear 54 can mesh with a lower gear 81b provided to the toy top 80, which is described later.

In addition, in a portion of the circumference of the approximately circular field 50, the rack rail 53 is curved to form curved portions 55 that protrude toward the center of the field 50, so that the toy top 80 that moves along the rack rail 53 can be guided toward the central portion 51.

The outer edge portion 61 includes a flat portion 64 provided so as to surround the rack rail 53, and pockets 65, connecting portions 66, and a wall portion 67 are formed adjacent to the outer periphery of the flat portion 64.

The flat portion 64 is a flat surface that is flush with the upper surface of the rack rail 53 and is inclined toward the central portion 51. This configuration can lead the toy top 80 that has jumped out of the field 50 back to the field 50.

The pockets 65 are recessed portions that are recessed so as to be lower than the flat portion 64. The pockets 65 are large enough to accommodate the toy top 80, and when the toy top 80 that has jumped out of the field 50 falls into the pockets 65, the toy top 80 cannot move.

The connecting portions 66 are portions for connecting the first component member 60 and the second component member 70, and each of the connecting portions 66 is provided with an engaged portion 68 that engages with an engaging member 41 that has inserted into an insertion portion formed in a connecting portion 71 of the second component member 70.

The wall portion 67 constitutes a wall that extends substantially vertically upward from the flat portion 64 and prevents the toy top 80 from flying out of the first component member 60.

The wall portion 67 is formed only between the two pockets 65, but the outer periphery of the flat portion 64 other than this portion is surrounded by the side surface portion 72 of the second component member 70, and in the portion where there is no wall portion 67, the side surface portion 72 of the second component member 70 prevents the toy top 80 from flying out of the first component member 60.

The second component member 70 has a shape that can cover the upper part of the first component member 60, and includes the connecting portions 71 each having the insertion portion through which the engaging member 41 for attaching the first component member 60 can be inserted, the side surface portion 72 that forms the side surface, and an upper surface portion 73 that forms the upper surface that is continuous with the upper part of the side portion 72.

Each of the connecting portions 71 are provided at a position facing each of the connecting portions 66 of the first component member 60, and an insertion portion that is an opening that penetrates vertically is formed at each of positions facing the engaged portions 68. By engaging the engaging members 41 being inserted in the insertion portions with the engaged portions 68, the second component member 70 is attached to the first component member 60 at a predetermined position.

When the second component member 70 is attached to the first component member 60, the side surface portion 72 is arranged so as to overlap with the outside of the side surface portion 62 of the first component member 60, and the lower end is arranged at approximately the same height as the flat portion 64 of the first component member 60. With this configuration, the outer periphery of the flat surface portion 64 of the first component member 60 is surrounded by the side surface portion 72, and the toy top 80 is prevented from flying out of the first component member 60.

The upper surface portion 73 has an opening 74 formed in the center, and the central part of the field 50 can be seen through the opening 74 from above the stadium 40. This allows the toy top 80 to be launched into the field 50 through the opening 74.

The periphery of the opening 74 is provided with an inclined surface 75 that slopes downward toward the center of the opening 74, so that the toy top 80 is guided into the opening 74 even when the toy top is launched and bumps the periphery.

In the stadium 40 configured as described above, at least the central portion 51 and the inclined portion 52 of the field 50 have the function of transmitting irradiated light and scattering part of the light. With this configuration, the field serves as a screen, and the image projected by the projection device 17 onto the lower surface of the field 50 is projected onto the field 50, making the image visible from above the field 50.

According to the present embodiment, the toy top 80 is used as the moving object, and the second component member 70 is provided so as to cover the field 50 in order to prevent the toy top 80 from flying out. Therefore, if the image is projected from above the field 50, the second component member 70 may be an obstacle, but by projecting from below the field 50, the image can be projected without any obstacle.

Furthermore, if the image is projected from above the field 50, it cannot be projected onto the part of the field 50 that is shaded by the toy top 80, but by projecting from below the field 50, it is possible to project the image onto a position close to the toy top 80.

In addition, since no image is projected onto an upper part of the toy top 80, the design of the toy top 80 and the projected image do not overlap, and there is no need to consider the visibility of the projected display in relation to the design of the toy top 80, which increases the degree of freedom and improves the enjoyment of playing with the moving object.

Note that other parts of the stadium 40 may also be made to be capable of transmitting and scattering the irradiated light, or may not have such a function.

For example, the rack rail 53 may be made of an opaque material to ensure strength.

The outer edge portion 61 surrounding the periphery of the field 50 may be capable of transmitting the irradiated light and also have the function of scattering part of the light, and the image may be projected onto the outer edge portion 61 as well.

By making the side surface portion 62 that forms the side and lower end of the first component member 60 opaque to prevent external light from entering the underside of the field 50, the visibility of the image projected onto the field 50 can be improved.

When the second component member 70 is made of a transparent material that can transmit but does not scatter the irradiated light, the image projected onto the field 50 can be clearly seen even from the part covered by the second component member 70. Furthermore, when the camera 15 is capable of transmitting light that can capture images, the toy top 80 can be easily captured by the camera 15 even if it moves into the area covered by the second component member 70.

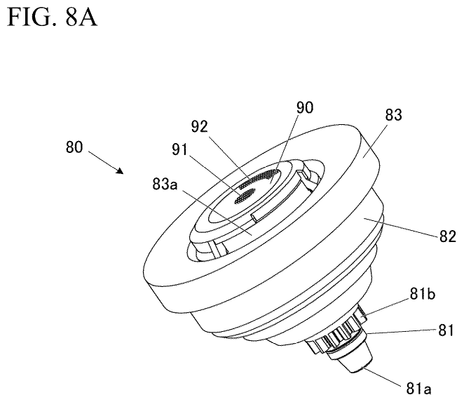

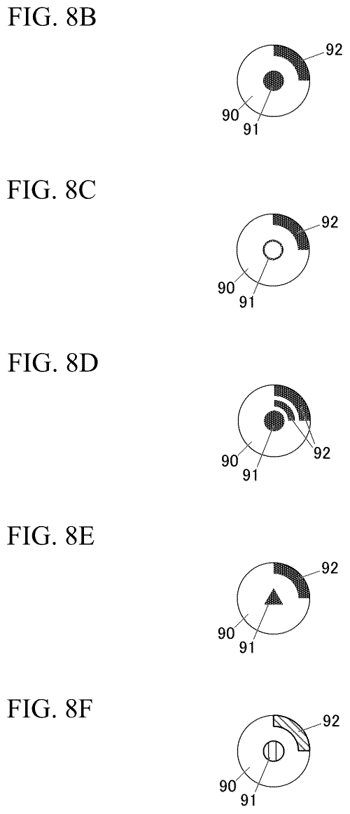

FIG. 8A illustrates a perspective view of the toy top 80 that serves as the moving object.

The toy top 80 according to the present embodiment is played with by being rotated with a tip 81a in contact with the ground. The toy top 80 can be used in a battle game in which, for example, two toy tops 80 are rotated within the field 50, and the battle is settled when one of the toy tops 80 stops the other toy top 80 from rotating, breaks it apart, or throws it out of the stadium 40 by impact force of collision.

The toy top 80 includes a shaft portion 81, a first body portion 82 attached to the top of the shaft portion 81, and a second body portion 83 attached to the top of the first body portion 82. The shaft portion 81 and the first body portion 82, and the first body portion 82 and the second body portion 83 are made to be detachably attached, respectively. Furthermore, there are a plurality of types of shaft portion 81, first body portion 82, and second body portion 83, and a user can change the characteristics of the toy top 80 by arbitrarily selecting and combining them.

The shaft portion 81 is a component that mainly constitutes the rotation shaft of the toy top 80, and there are several types that differ in weight, center of gravity, material, shape of the tip 81a that comes into contact with the ground, and the like. The shaft portion 81 is provided with a lower gear 81b, which can change the motion state of the toy top 80 by meshing with the rack rail 53 of the field 50.

The first body 82 is a member that mainly functions to stabilize the rotation of the toy top 80 and to come into contact with the other toy top 80, and there are multiple types that differ in weight, center of gravity, material, shape, and the like.

The second body portion 83 is a member that mainly functions to come into contact with the other toy top 80, and there are a number of types that differ in weight, center of gravity, material, shape, and the like. Further, at the top of the second body portion 83, a connection hole 83a is provided into which a holding piece provided to a launcher that can hold the toy top 80 and release it in a rotating state is inserted.

Examples of materials for each of the above parts include rubber, metal, plastic, and the like.

The toy top 80 is not limited to being composed of three parts, but may also be composed of one part, two parts, or four or more parts.

An identification marker 90 is provided in the center of the upper surface of the second body portion 83, which forms the upper surface of the toy top 80, to enable recognition by the camera 15.

As illustrated in FIG. 8B, the identification marker 90 includes a circular first identifier 91 and a second identifier 92 arranged circumferentially along a portion of the circumference of a circle concentric with the circular first identifier 91, and is arranged so that the center of the circular first identifier 91 and the rotation shaft of the toy top 80 approximately coincide with each other.

The first identifier 91 and the second identifier 92 are made of a reflective material that can reflect light. According to the present embodiment, an infrared camera is used as the camera 15, and the reflective material is a material that can reflect infrared rays.

The identification marker 90 may be formed directly on the toy top 80, or a member on which the identification marker 90 is formed may be attached to the toy top 80.

In addition, different forms of identification markers can be used, and by using different identification markers 90 for each of the multiple toy tops 80 launched into the field 50, the control device 30 can identify each toy top 80.

For example, the first identifier 91 may be hollowed out as illustrated in FIG. 8C, the second identifier 92 may be composed of two lines along the circumferential direction as illustrated in FIG. 8D, the first identifier 91 may have a different shape as illustrated in FIG. 8E, or a predetermined pattern may be applied to the first identifier 91 or the second identifier 92 as illustrated in FIG. 8F.

Needless to say, other forms may be used as long as the control device 30 can identify the toy tops 80.

Next, detection of the motion state of the toy top 80 using the identification marker 90 will be described.

The control device 30 can obtain a movement speed, a movement direction, and a rotation speed of the toy top 80 as the motion state from the image captured by the camera 15.

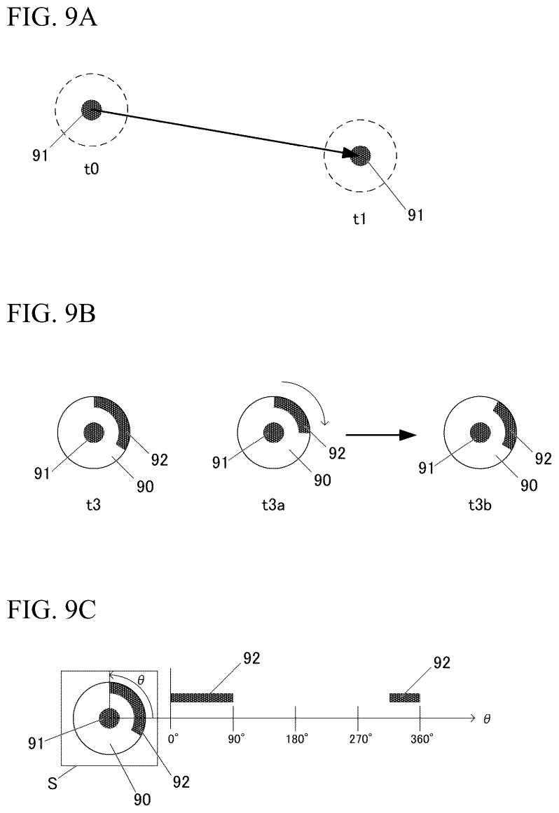

FIG. 9A illustrates states of the first identifier 91 in two consecutive frames, that is, states in a frame t1 and a frame t0, which is the frame immediately before frame t1.

The control device 30 can obtain the current position of the toy top 80 by recognizing the first identifier 91 from the image of the frame t1, which is the latest frame. The control device 30 can recognize the first identifier 91 by detecting a circle of a specific radius from the image of the camera 15, for example.

Then, the difference between the position of the first identifier 91 in the frame t1 and the position of the first identifier 91 in the frame t0 is calculated. With this configuration, the moving direction and moving distance of the toy top 80 can be obtained. Furthermore, since the time from the frame to t0 the frame t1 can be determined from the frame rate of the camera 15, the moving speed during this period can be calculated.

FIG. 9B illustrates images of the identification marker 90 in a frame t3 and is a diagram for explaining the formation process thereof.

The images of the identification marker 90 in the frame t3 reflect the rotation of the identification marker 90 during an exposure time of the camera 15. In this example, the state of the identification marker 90 is t3a at the start of the exposure time of the camera 15, and from this state the identification marker 90 rotates clockwise, reaching the state of t3b at the end of the exposure time of the camera 15. Therefore, in the image of the identification marker 90 in the frame t3, the second identifier 92 appears stretched in the circumferential direction.

Since the exposure time of the camera 15 is constant, the circumferential length of the second identifier 92 in the image of the identification marker 90 increases as the rotation speed increases. Therefore, the rotation speed of the toy top 80 can be obtained based on the circumferential length of the second identifier 92 in the image of the identification marker 90.

More specifically, after the first identifier 91 is recognized as described above, a square S is cut out from the image around the first identifier 91 as illustrated in FIG. 9C. Next, to convert from polar coordinates to Cartesian coordinates centered on the center position of the first identifier 91, the radius of the polar coordinates is set as one axis of the Cartesian coordinates (here, the vertical axis) and the angle of the polar coordinates is set as the other axis of the Cartesian coordinates (here, the horizontal axis), and the image is expanded into Cartesian coordinates. As a result, the second identifier 92 is expressed as a straight line, and the rotation speed is calculated based on the length of the second identifier 92 and the exposure time of the camera 15.

It is also possible to obtain the rotation direction of the toy top 80 from the images of two consecutive frames and the rotation speed. It is also possible to obtain the tilt direction and angle of the rotation shaft of the toy top 80 relative to the vertical direction from the positional relationship and distortion of the first identifier 91 and the second identifier 92 in the image. Furthermore, when installation information such as the position and orientation of the field 50 in the installation section 11 and information on the tilt angle of the field 50 are available, it is also possible to obtain the tilt direction and angle of the rotation shaft of the toy top 80 relative to the surface of the field 50 by considering the position information of the toy top 80.

Furthermore, when the control device 30 recognizes the identification marker 90, the difference in the form of the first identifier 91 and the second identifier 92 can be recognized as illustrated in FIGS. 8B to 8F. Thus, by attaching differently shaped identification markers 90 to a plurality of toy tops 80, it is possible to identify each toy top 80 and obtain its individual motion state. The control device 30 stores the acquired motion state of the toy top 80 over time, and can display the information on the field 50 based on the information, or can use the information as a record of the results of the game.

Next, the display in the field 50 corresponding to the motion state of the toy top 80 will be described.

The control device 30 is capable of acquiring the motion state of the toy top 80 as described above, and displays an effect display corresponding to the motion state of the toy top 80 on the field 50 based on the acquired information. The effect display may be one of first to seventh images.

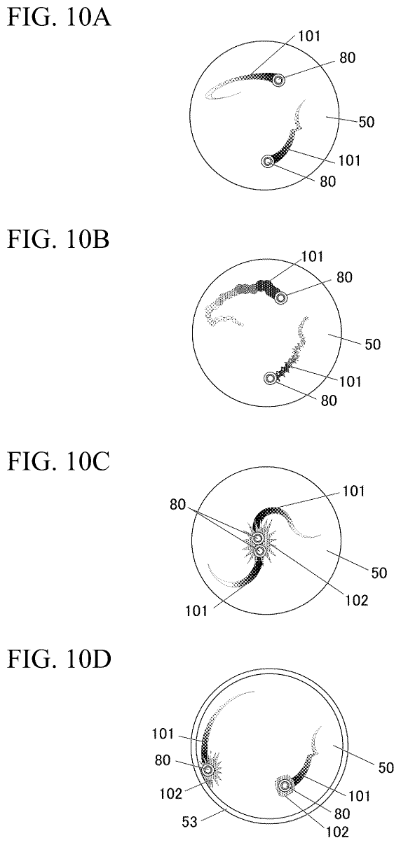

As such an effect display, a trajectory display 101 that follows the trajectories of the toy tops 80 can be displayed as illustrated in FIG. 10A.

The control device 30 displays the trajectory display 101 along the trajectories of the toy tops 80 over a predetermined period of time until the toy tops 80 reach current positions. In the trajectory display 101, the width becomes wider the closer it is to the current position of the toy top 80, and the color changes according to the distance from the current position, making it easier to understand the movement route.

The trajectory display 101 may be displayed within a range corresponding to a predetermined movement distance up to the current position. With such a configuration, when the moving speed is fast, the trajectory display 101 becomes longer, making it easier to visually grasp the moving speed.

Furthermore, the display state of the trajectory display 101 can be changed according to various parameters other than the distance from the current positions. The parameters include the moving speed, the rotation speed, the rotation direction, the tilt of the rotation shaft, the position relative to the field 50, and the shape of the trajectory of the toy top 80.

Furthermore, the trajectory display 101 is not limited to a linear display as illustrated in FIG. 10A, but may be configured by figures, marks, etc. as illustrated in FIG. 10B.

By displaying such a trajectory display 101, the changes in the toy tops 80 over time can visually be grasped. In addition, by displaying the trajectories of the toy tops 80, the moving destination of the toy tops 80 can be predicted, and the occurrence of collisions between the toy tops 80 can be predicted, thereby increasing the enjoyment of the game.

As illustrated in FIG. 10C, the control device 30 can perform a collision display 102, as an effect display, that decorates the collision of the toy tops 80. The control device 30 determines that the two toy tops 80 have collided when the two toy tops 80 come within a certain distance of each other, and displays the collision display 102 near the toy tops 80.

There are various types of collision display 102 that can be selected by the control device 30 randomly or according to predetermined conditions. The predetermined conditions include the relative speed at the time of collision, the angle of collision, and the position of the collision location relative to the field 50.

Since the diameter of the toy tops 80 varies depending on the type, the above-mentioned certain distance may be, for example, a distance equal to the diameter of the toy top 80 having the largest diameter, or a distance equal to the average diameter of the toy tops 80.

In other words, the collision display 102 does not necessarily indicate that the toy tops 80 have collided, and can also be considered an approach display indicating that the toy tops 80 have approached each other.

Such a collision display 102 may be started when the toy tops 80 approach each other within a predetermined distance that is longer than the certain distance at which the toy tops 80 are determined to have collided, and the display state may be changed depending on the distance between the toy tops 80.

As illustrated in FIG. 10D, the control device 30 can display, as an effect display, a position display 103 that decorates the current position of the toy top 80.

There are various types of position display 103, and the control device 30 can select one randomly or according to a predetermined condition. The predetermined condition includes the current position, the movement speed, the rotation speed, the rotation time of the toy top 80, the time the toy top 80 rotates without coming into contact with other toy tops 80, and the like.

Furthermore, when the position displays 103 displayed on each of the two toy tops 80 overlap, an effect display such as the collision display 102 may be displayed.

The predetermined condition for selecting the position display 103 may be the position relative to the field 50, or a specific display state may be set based on the toy top 80 coming into contact with the rack rail 53, as illustrated in FIG. 10D. In this case, the control device 30 is configured to grasp the position of the rack rail 53 in advance from the image of the camera 15. When necessary, the rack rail 53 may be provided with a reflective material similar to the identification marker 90.

The control device 30 then determines that the toy top 80 has come into contact with the rack rail 53 based on the fact that the toy top 80 approaches within a certain distance of the rack rail 53. In other words, the display in this case does not necessarily indicate that the toy top 80 has come into contact with the rack rail 53, and can also be considered an approach display indicating that the toy top 80 has approached the rack rail 53. Furthermore, the display state may be changed according to the distance between the toy top 80 and the rack rail 53, or the speed and angle at which the toy top 80 moves towards the rack rail 53.

Noted that the collision and contact with the rack rail 53 may be determined based on a predetermined change in the rotation speed or the movement direction of the toy top 80. In the event of a collision or contact with the rack rail 53, the rotation speed and the direction of movement of the toy top 80 change significantly, so the expected changes in such cases may be specified in advance to determine that a collision or contact with the rack rail 53 has occurred when such changes occur.

Further, when a toy top 80 approaches within a certain distance of another toy top 80 or the rack rail 53 and the rotation speed or direction of movement changes as described above, it may be determined that there has been a collision between the toy tops 80 or contact with the rack rail 53. In this manner, a collision or contact with the rack rail 53 can be determined more accurately.

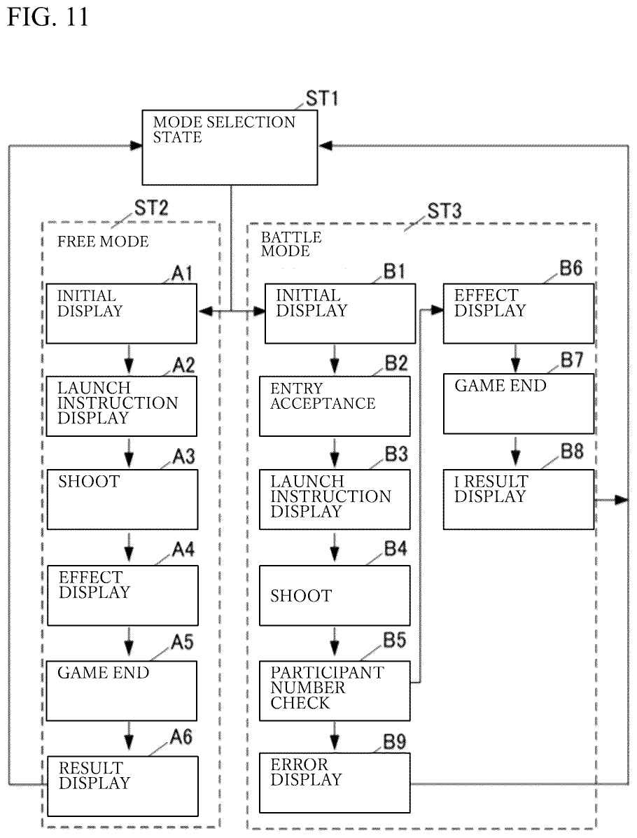

Next, an example of a game using the game device 1 will be described. FIG. 11 illustrates a main flow of the game.

Game modes include a free mode ST2 in which a single player plays, and a battle mode ST3 in which multiple players play together, and the mode can be selected in a mode selection state ST1. In the mode selection state ST1, the control device 30 displays selectable game mode items on the touch panel display 19, and the player can select by touching the desired item.

Furthermore, the control device 30 can display information about the game and various images on the field 50 in addition to the touch panel display 19.

When the free mode is selected in the mode selection state ST1, the control device 30 transitions to the free mode ST2 and displays an initial display A1. In the initial display A1, information about the game is displayed. In the free mode ST2 according to the present embodiment, virtual enemies 111 are projected onto the field 50, and the toy top 80 can defeat the virtual enemies 111 by passing through the areas where the virtual enemies 111 are displayed.

Next, the control device 30 displays a launch instruction display A2 that prompts the player to prepare to launch the toy top 80 or displays an instruction to launch the toy top 80.

Then, the player performs a shoot A3 to launch the toy top 80 into the field 50. The control device 30 recognizes that the shoot A3 has been performed based on recognition of the identification marker 90 attached to the toy top 80 on the field 50.

Thereafter, the control device 30 performs an effect display A4. Here, processing such as projecting an effect display corresponding to the motion state of the toy top 80 onto the field 50 and collecting data on the motion state of the toy top 80 is performed. The data collected by the control device 30 includes the number of virtual enemies 111 defeated, maximum rotation speed, rotation time, maximum movement speed, number of contacts with the rack rail 53, and the like.

When a predetermined time passes since the launch instruction display A2 is performed without the shoot A3 being recognized, the free mode ST2 may be ended and the state may transition to the mode selection state ST1. Also, when more than one toy top 80 is recognized between the launch instruction display A2 and a game end A5, the free mode ST2 may be ended and the state may transition to the mode selection state ST1.

Then, when recognizing the game end A5, the control device 30 displays a message that the game has ended, and performs a result display A6 that displays information about the game results and prompts the player for the next game, and then transitions to the mode selection state ST1.

The control device 30 determines the state of the game end A5 when all the virtual enemies 111 are defeated, or when the toy top 80 stops spinning or the identification marker 90 is no longer detected before all the virtual enemies 111 are defeated. In a case where the identification marker 90 of the toy top 80 cannot be captured, the toy top 80 may turn upside down. In addition, by considering the possibility that the identification marker 90 cannot temporarily be captured even though the toy top 80 has not stopped rotating, the game end A5 may be determined based on the fact that the identification marker 90 has not been captured for a predetermined period of time.

In addition, since the current position of the toy top 80 can be grasped, the control device 30 can determine whether the toy top 80 has finished the game inside or outside the field 50 based on the position where the toy top 80 stopped spinning and the current position just before the identification marker 90 of the toy top 80 is no longer captured, and this determination can be used as information on the result.

Furthermore, when the battle mode is selected in the mode selection state ST1, the control device 30 transitions to the battle mode ST3 and displays an initial display B1. In the initial display B1, information on the game is displayed. In the battle mode ST3 according to the present embodiment, two or three players launch the toy tops 80 into the field 50, and the toy top 80 that continues to spin until the end is the winner.

Next, the control device 30 performs an entry acceptance B2 to wait for opponent's entry, and displays a launch instruction display B3. In the entry acceptance B2, the process waits until a predetermined time (for example, 90 seconds) has elapsed. After the predetermined time has elapsed, a display prompting the players to prepare to launch the toy tops 80 or a display instructing the players to launch the toy tops 80 is displayed as the launch instruction display B3.

Thereafter, the players perform a shoot B4 to launch the toy tops 80 into the field 50. The control device 30 recognizes that the shoot B4 has been taken based on the recognition of the identification markers 90 attached to the toy tops 80 on the field 50.

Then, the control device 30 performs a participant number check B5 to confirm the number of toy tops 80 that have been launched into the stadium. Here, when the number of toy tops 80 corresponding to the number of selected players is recognized, it is determined that the game has started normally. When a predetermined time has passed without recognizing the number of toy tops 80 corresponding to the number of selected players after the launch instruction display B3 is performed, an error display B9 is performed, the battle mode ST3 ends, and the state shifts to the mode selection state ST1.

In addition, when a number of toy tops 80 exceeding the number of selected players is recognized between the launch instruction display B3 and a game end B7, the error display B9 may be displayed, the battle mode ST3 may be ended, and the mode selection state ST1 may be entered.

Thereafter, the control device 30 performs an effect display B6. Here, processing such as projecting an effect display corresponding to the motion state of each toy top 80 onto the field 50 and collecting data on the motion state of the toy top 80 is performed.

The data collected by the control device 30 for each toy top 80 includes the win-loss record, maximum rotation speed, rotation time, maximum movement speed, number of contacts with other toy tops 80, number of contacts with the rack rail 53, and the like.

Then, when recognizing the game end B7, the control device 30 displays a message that the game has ended, and displays a result display B8 that displays a message that a winner has been determined and a message prompting the player for the next game, and then transitions to the mode selection state ST1.

The control device 30 recognizes the game end B7 when only one toy top 80 remains rotating in the field 50. In other words, the other top toys have stopped rotating or have fallen upside down and the identification markers 90 are no longer captured. In addition, by considering the possibility that the identification marker 90 cannot temporarily be captured even though the toy top 80 has not stopped rotating, the game end B7 may be determined based on the fact that there is only one toy top 80 that has been rotating on the field 50 for more than a predetermined period of time.

Since the current position of each toy top 80 can be grasped, the control device 30 can determine whether each toy top 80 has ended the game inside or outside the field 50 based on the position where the losing toy top 80 stopped spinning and its current position just before the identification marker 90 is no longer captured, and this determination can be used as the information on the result. Furthermore, it is also possible to determine whether the toy top 80 has fallen into the pocket 65, and in this case, a specific effect display may be performed.

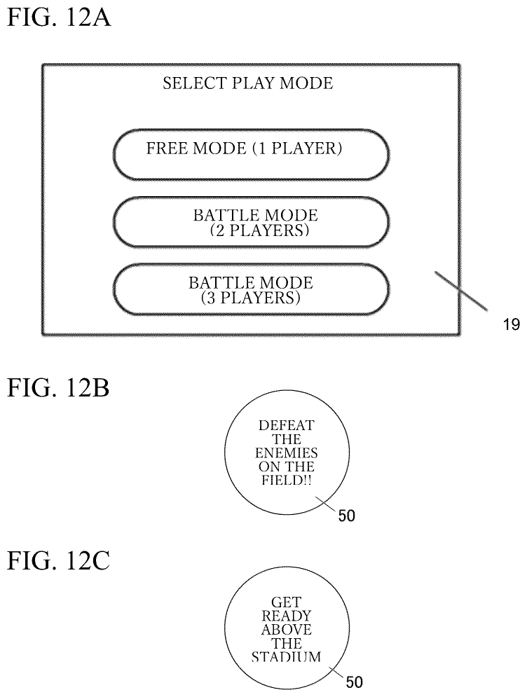

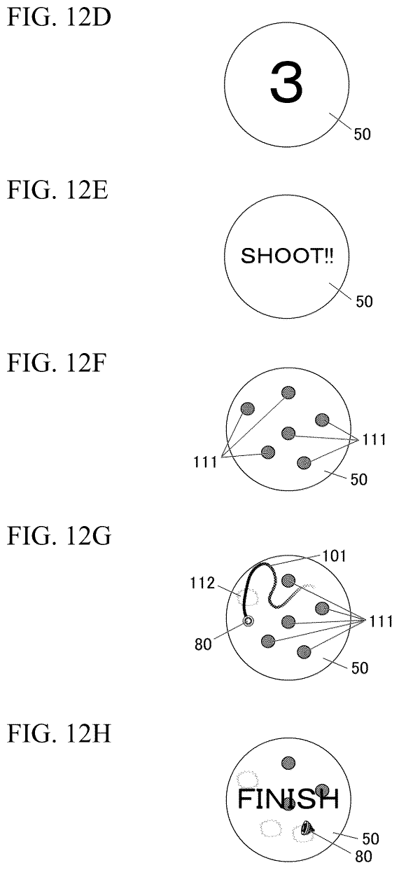

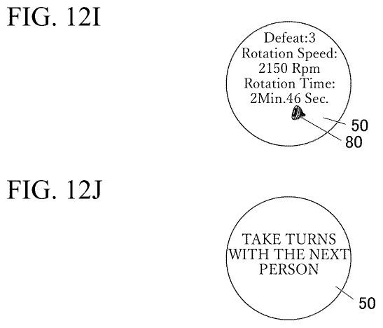

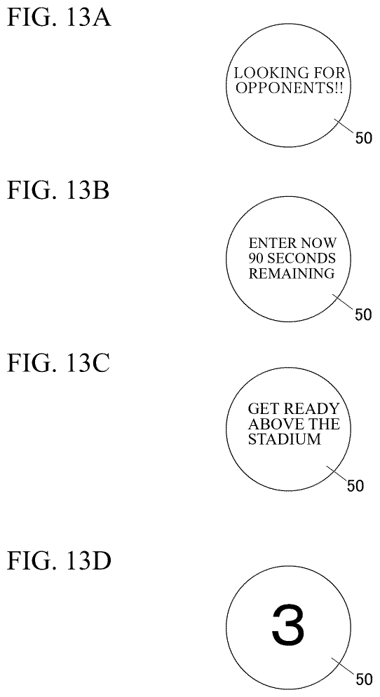

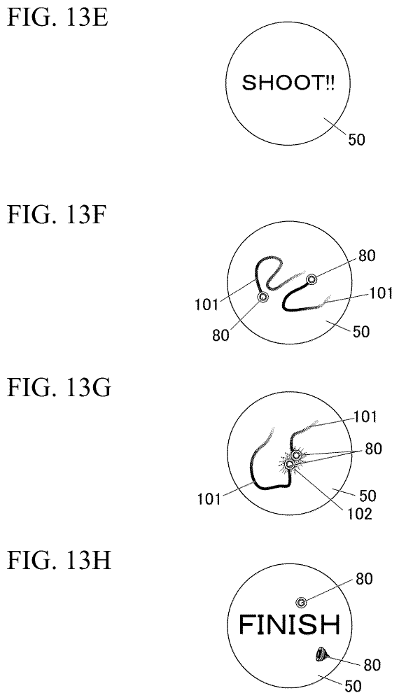

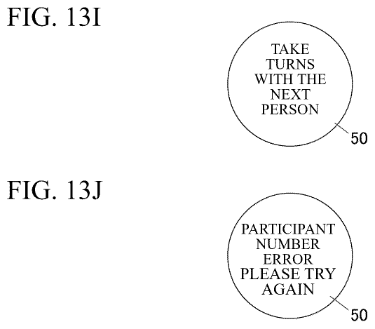

In FIGS. 12A to 12J and 13A to 13J illustrate examples of displays on the touch panel display 19 and the field 50.

As illustrated in FIG. 12A, in the mode selection state ST1, selectable items are displayed on the touch panel display 19. Here, the items of a free mode, a battle mode (two players) and a battle mode (three players) are displayed.

When the free mode item is selected, first, information about the game is displayed on the field 50 as the initial display Al, as illustrated in FIG. 12B. In this example, explanation of defeating virtual enemies 111, which are projected onto the field, is displayed.

Next, as a display in the launch instruction display A2, a display is displayed on the field 50 prompting the player to prepare to launch the toy top 80 as illustrated in FIG. 12C, a countdown display is displayed on the field 50 as illustrated in FIG. 12D, and then a display is displayed on the field 50 instructing the player to launch the toy top 80 as illustrated in FIG. 12E. Furthermore, the virtual enemies 111 are displayed on the field 50 as illustrated in FIG. 12F.

In the effect display A4, the control device 30 recognizes the position and the motion state of the toy top 80 based on the image from the camera 15, and displays the trajectory display 101 and the like along the trajectory of the toy top 80.

Also, when it is determined that the toy top 80 has come into contact with the virtual enemies 111, the virtual enemies 111 are deemed to have been defeated and the state changes to a defeated state 112. The determination of contact with the virtual enemies 111 is made in the same way as the determination of a collision with the toy top 80, by determining that the toy top 80 and the virtual enemies 111 approach within a certain distance.

At the timing of the game end A5, a display indicating that the game has ended is displayed on the field 50 as illustrated in FIG. 12H. Thereafter, in the result display A6, information on the result of the game is displayed on the field 50 as illustrated in FIG. 12I. Here, since all of the virtual enemies 111 are not defeated, the number of defeated virtual enemies 111, the maximum rotation speed, and the rotation time are displayed. When all the virtual enemies 111 are defeated, the time it took to defeat them and the maximum rotation speed are displayed. Thereafter, a display as illustrated in FIG. 12J is performed to prompt the player for the next game.

The virtual enemies 111 may be made to move. Furthermore, although it has been assumed that the toy top 80 defeats the virtual enemies 111 once the toy top 80 passes through the areas where the virtual enemies 111 are displayed, it may be determined that the enemies are defeated if the toy top 80 passes through multiple times. Also, the greater the rotation speed or movement speed when passing, the greater the damage inflicted on the virtual enemies 111, so that the virtual enemies 111 may be defeated when a predetermined damage is inflicted.

FIGS. 13A to 13J illustrate examples of the display on the field 50 in the battle mode.

When the battle mode item is selected in the mode selection state ST1, first, as illustrated in FIG. 13A, a display inviting opponents is displayed on the field 50 as the initial display B1.

Next, as a display in the entry acceptance B2, a display indicating that entry acceptance is in progress and the remaining time are displayed on field 50 as illustrated in FIG. 13B.

Then, as the display in the launch instruction display B3, a display is displayed on the field 50 prompting the players to prepare to launch the toy tops 80 as illustrated in FIG. 13C, a countdown display is displayed on the field 50 as illustrated in FIG. 13D, and then a display is displayed on the field 50 instructing the players to launch the toy tops 80 as illustrated in FIG. 13E.

When the number of toy tops 80 corresponding to the number of players selected can be recognized in the participant number check B5, the effect display B6 period begins, and the positions and motion states of the toy tops 80 are recognized based on the images from the camera 15, and effect displays as illustrated in FIGS. 10A to 10D are performed. For example, as illustrated in FIG. 13F, the trajectory display 101 is displayed along the trajectories of the toy tops 80, and when it is determined that the toy tops 80 are collided, the collision display 102 is displayed as illustrated in FIG. 13G.

Furthermore, when a predetermined time has elapsed in the participant number check B5 without recognizing the number of toy tops 80 corresponding to the number of selected players, a display indicating that an error has occurred is displayed in the error display B9 on the field 50 as illustrated in FIG. 13J.

At the time of the game end B7, a display indicating that the game has ended is displayed on the field 50 as illustrated in FIG. 13H. Thereafter, in the result display B8, a display such as illustrated in FIG. 13I prompting the players for the next game is displayed on the field 50.

The touch panel display 19 and the second display device 31 are configured to display the same information as that displayed on the field 50. For example, for FIGS. 12B to 12E, 12H to 12J, and 13A to 13E, and 13H to 13J, the same information as that displayed on field 50 is displayed. For FIGS. 12F, 12G, 13F, and 13G, which are periods of the effect displays A4 and B6, the images captured by camera 15 may be displayed on the touch panel display 19. In this case, the image from the camera 15 may be displayed as is, or a separate camera capable of taking color images may be provided and the image captured by this camera may be displayed.

### First Modification

Next, a first modification of the above-described embodiment will be described. Basically, the same configuration as the game device 1 according to the above-described embodiment is provided, and in the following, parts having the same configuration will be given the same reference numerals and explanations will be omitted, and mainly the different parts will be explained. The game device 1 according to the present modification can constitute a game system that uses an external server 23.

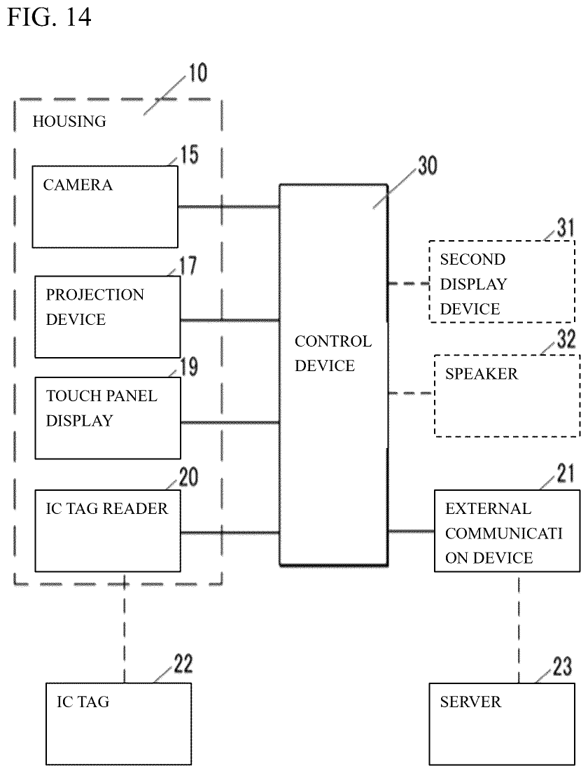

FIG. 14 illustrates a block diagram illustrating a control system of the game device 1 and the game system according to the present modification.

The housing 10 of the game device 1 is provided with an IC tag reader 20 capable of reading information from an IC tag 22 that stores information about the player, and the control device 30 can obtain information from the IC tag reader 20.

The game device 1 is also provided with an external communication device 21 that enables communication with an external device. With this configuration, the control device 30 can communicate with the server 23 via a communication line, and information related to the games can be transmitted and received.

The server 23 stores information about players, information about games associated with each player, information about game control, and the like.

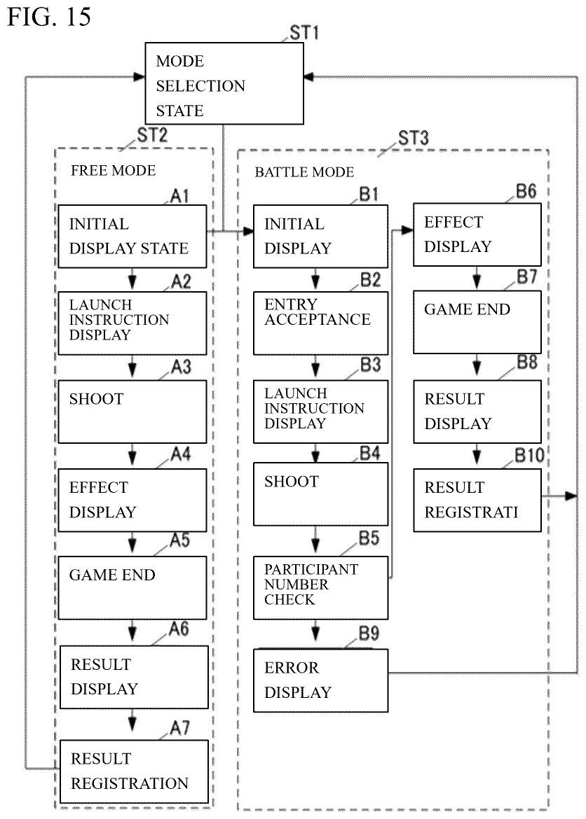

FIG. 15 illustrates a main flow of a game using the game device 1 according to the present modification.

In a game using the game device 1 according to the present modification, a result registration A7 can be performed in the free mode ST2, which associates the players with the game results. Similarly, in the battle mode ST3, a result registration B10 can be performed, which associates the players with the game results.

In the result registration A7, B10, when the player causes the IC tag reader 20 to read the IC tag 22, the control device 30 obtains information of the player, and then transmits the obtained information of the player and information on the game result to the server 23.

The server 23 performs a process to add the result of the current game to the information about the games managed for each player.

The information about the player in the IC tag 22 includes at least an ID that can identify the player. In addition, the information about the results of the game includes information collected by the control device 30 during the game, such as, in the free mode ST2, the number of defeated virtual enemies 111, maximum rotation speed, rotation time, maximum movement speed, and number of contacts with the rack rail 53. In the battle mode ST3, information on the maximum rotation speed, rotation time, win/loss information of the player, number of contacts with other toy tops 80, number of contacts with the rack rail 53, and the like can be included.

Other information may be collected by the game device 1, such as information on the rotation direction of the toy top 80, tilt of the rotation shaft, position relative to the field 50, and trajectory. It may also include information about the venue where the game device 1 is installed, date and time of the game, name of the tournament, and the like.

The server 23 not only stores the received information, but also performs various processes using the stored information and can output the information to the outside. The information may be output to the game device 1, or may be sent to a terminal device owned by the player via the Internet or the like. These devices display the information received from the server 23 so that the player can check the content.

The processing performed by the server 23 using the stored information includes, for example, making comparisons and rankings based on the player's game results and the game results of other players. Furthermore, if the accumulated game results meet a predetermined condition, the player can be given reward such as a title or a prize.

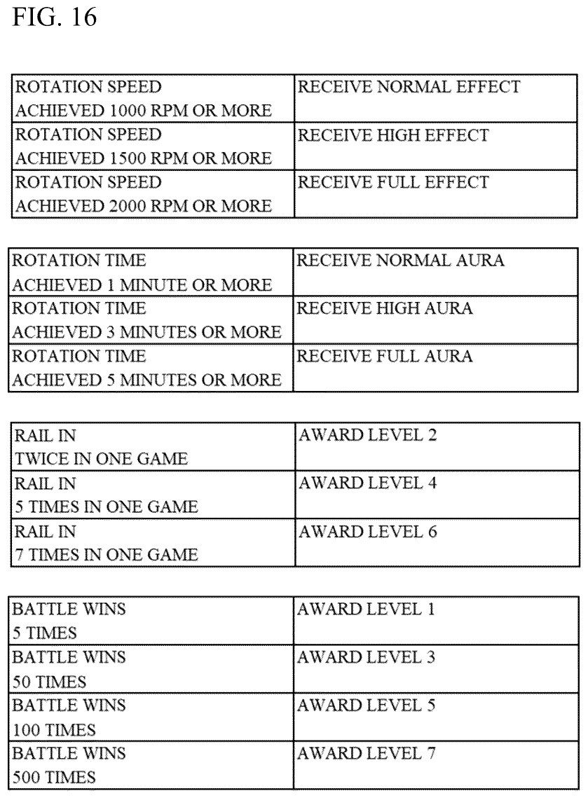

FIG. 16 illustrates examples of the reward that can be given.

When the maximum rotation speed reaches 1,000 rpm or more, a normal effect display can be used as the type of the trajectory display 101. Furthermore, when the maximum rotation speed reaches 1,500 rpm or more, a high effect display can be used as a type of the trajectory display 101, and when the maximum rotation speed reaches 2,000 rpm or more, a full effect display can be used as a type of the trajectory display 101.

When the rotation time reaches one minute or more, a normal aura display can be used as the position display 103. When the rotation time reaches three minutes or more, a high aura display can be used as the position display 103, and when the rotation time reaches five minutes or more, a full aura display can be used as the position display 103.

When the player achieves a rail-in, which is contacting with the rack rail 53, twice in one game, a title of Level 2 is awarded. Additionally, when the player achieves the rail-in five times in one game, a title of Level 4 is awarded, and when the player achieves the rail-in seven times in one game, a title of Level 6 is awarded.

When the player wins five times in the battle mode, a title of Level 1 is awarded. When the player wins 50 times in the battle mode, a title of Level 3 is awarded, when the player wins 100 times in the battle mode, a title of Level 5 is awarded, and when the player wins 500 times in the battle mode, a title of Level 7 is awarded.

In the above explanation, the IC tag 22 and the IC tag reader 20 are used as a method for identifying the players, but any method that can identify the players may be used.

For example, a code may be displayed on the touch panel display 19, the code may be read by a terminal device owned by the player, and the terminal device may access the server 23 and transmit information about the code along with information identifying the player, thereby authenticating the player.

In addition, the game device 1 may be equipped with a camera capable of reading codes, and the game device 1 may read a code that can identify the player displayed on a terminal device owned by the player, and the game device 1 may access the server 23 and transmit the code that can identify the player, thereby authenticating the player.

Furthermore, the timing at which the control device 30 reads the information of the player from the IC tag 22 is not limited to the result registration A7 and B10, but may be any timing. For example, it may be read when the play mode is selected in the mode selection state ST1.

Furthermore, in the entry acceptance B2 in the battle mode ST3, by reading the information of the player from the IC tag 22 and also reading the identification marker 90 on the toy top 80 used by the player, the player can be associated with the toy top 80, and data during the games can be collected in association with the player.

It should be noted that the sizes of the toy top 80, the game device 1, the field 50, and the like in the above-described embodiment and modification can be set arbitrarily.

Although the images are projected from below the field 50, the images may be projected from above the field 50. In this case, the images may be projected only onto the corresponding portion of the field 50 that is visible through the opening 74 of the second component member 70, or may be projected onto the entire stadium 40.

Although the projection device 17 is used as a display means for displaying the images on the field 50, it is also possible to provide a display device such as a liquid crystal display device below the field 50 so that the image on the display device can be seen through the field 50, thereby displaying the image on the field 50.

Although an infrared camera was used as a capturing means capable of capturing the motion of moving objects present on the field 50, a camera capable of capturing images that can identify the shape of the toy top 80, such as a camera capable of capturing visible light, may also be used, and the image may be analyzed by the control device 30 to obtain the motion state of the toy top 80. In this case, if necessary, a configuration such as the identification marker 90 used to detect the position and rotation of the toy top 80 may be added. In a case where a camera capable of identifying the shape of the toy top 80 is used, a burst finish, in which the toy top 80 breaks apart and the game ends, can be detected.

When a camera capable of identifying the shape of the toy top 80 is used, the toy top 80 may be photographed and registered before the start of the game. For example, in the entry acceptance B2 in the battle mode, the toy tops 80 of the players who have entered may be photographed and stored in association with the type of identification marker 90, and the winner's toy top 80 may be displayed in the result display B8. In the configuration of the first modification, information about the toy top 80 may be acquired in the server 23 based on the image of the toy top 80 used in the game and stored as information about the player.

Furthermore, a sensor other than a camera may be used as the capturing means capable of capturing the motion of the moving object present on the field 50.

When a camera capable of distinguishing colors is used, the type of identification markers 90 can be distinguished by using identification markers 90 with different colors.

Although it has been described that the camera is installed directly above the center of the field 50, the camera may be installed in any other location as long as it can capture the toy tops 80 in the field 50.

As explained in FIG. 9C, it has been described that the absolute rotation speed of the toy top 80 is calculated based on the length of the second identifier 92 in the image of the identification marker 90 and the exposure time of the camera 15, but it is not necessary to calculate the absolute rotation speed.

For example, a length value of the second identifier 92 in the image may be used as the relative rotation speed. In this case, the rotation speed is zero when the length is equal to the length of the second identifier 92 itself, and the rotation speed increases as the length increases. In this manner, the calculation process of the rotation speed becomes simpler, and the load on the control device 30 can be reduced.

Furthermore, the possible values for the length of the second identifier 92 in the image may be divided into multiple stages, and the stage reached during the game may be determined, and the stage reached may be displayed as the maximum rotation speed in the result display, or reward may be given depending on the stage reached.

Alternatively, an image may be captured in advance at a specific rotation speed (for example, 1,000 rpm or 2,000 rpm) and the length of the second identifier 92 in that image may be stored as data, and the rotation speed may be calculated by comparing the length of the second identifier 92 in the image captured during play with the data.

In this case, the rotation speed may be calculated from the comparison result assuming that the length of the second identifier 92 and the rotation speed are proportional to each other, or only the result that the rotation speed is faster or slower than a specific rotation speed may be derived.

Furthermore, it may be possible to display a replay image that replays the behavior of the toy top 80 on the field 50 based on the motion state of the toy top 80 in the game that is stored in the control device 30. In this case, the shape of the toy top 80 may be a virtual shape, or when information on the shape of the toy top 80 that has actually been played with is available, the shape of that toy top 80 may be used.

For example, it may be used to reproduce the latest game, or may be used as the virtual enemies 111 in the free mode ST2, or may be used as an opponent in a competition of rotation times. Furthermore, in the result display B8 in the battle mode ST3, a replay image may be displayed that reproduces the state of a predetermined period when the battle is settled.

In addition, according to the first modification, information on the motion states of the toy tops 80 of the player, another player, or a virtual player may be stored in the server 23, and the stored information may be used to display a reproduced image on the game device 1.

In addition, the stadium 40 may be interchangeable, and the control device 30 may recognize the type of stadium 40 based on an image from the camera 15 or input from the touch panel display 19, or the like. When the stadium 40 is recognized based on the image from the camera 15, the stadium 40 may be recognized by its shape, or an identification code that can be photographed by the camera 15 may be provided on the stadium 40, and the stadium 40 may be recognized based on the identification code.

Furthermore, the control device 30 may be configured to acquire position information such as the installation position, orientation, and angle of the stadium 40 relative to the housing 10 from the image of the camera 15. Then, the image to be projected may be adjusted based on the acquired position information. With this configuration, the position and shape of structures such as the rack rail 53 can be accurately grasped, so the content of the presentation can be made more diverse and the enjoyment of the game can be improved.

Furthermore, the projected image can be adjusted to fit the position and shape of the field 50, and a background image may be displayed only on the field 50. In addition, since the tilt angle of the part to be projected can be grasped, a corrected image can be projected so that the image is not distorted.

The support plate 12 of the installation section 11 may be made of an opaque material. With this, an image can be projected only onto the portion of the stadium 40 facing the opening 13. Furthermore, external light entering from above can be reduced, making the projected image clearer and improving the visibility of the image. Furthermore, the cost of the game device 1 can be reduced, and a strong material such as metal can be used.

Furthermore, the embodiment disclosed herein should be considered to be illustrative in all respects and not restrictive. The scope of the present disclosure is indicated by the claims rather than by the above description, and is intended to include all modifications within the meaning and scope equivalent to the claims.

Effects According to a first aspect, the effect display can be displayed on the field, so the toy top can be designed without considering the visibility of the display, which increases the freedom of design and increases the enjoyment of playing with the toy top.

The effect display indicating the current position of the toy top can be displayed on the field, making it easier for players to grasp the position of the toy top, and the toy top can be decorated with the display, thereby increasing the enjoyment of playing with the toy top.

Furthermore, the type of the effect display can be changed depending on the motion state of the toy top, so that the motion state of the toy top can be visually grasped, and decorativeness is improved, thereby increasing the enjoyment of playing with the toy top.

In addition, since the toy top is a toy top that can move while rotating, random movement and collisions with other toy tops occur, and by displaying information based on the current position, movement state, and rotation state, the enjoyment of playing with the toy top can be increased.

According to the second aspect, a display indicating the trajectory of the movement of the toy top can be displayed on the field, so that the changes in the toy top over time can be visually grasped, thereby increasing the enjoyment of playing with the top toy.

Furthermore, by displaying the trajectory of the toy top, the moving destination of the toy top can be predicted, which increases the enjoyment of playing with the toy top.

According to the third aspect, the effect display indicating that the toy top has approached a predetermined position on the field can be displayed on the field, allowing the player to grasp that the toy top has approached the predetermined position and also making it possible to embellish the fact that the toy top has approached the predetermined position, thereby increasing the enjoyment of playing with the toy top.

According to the fourth aspect, the effect display indicating that two toy tops are approaching each other can be displayed on the field, allowing the player to grasp that the two toy tops are approaching each other, and the display can also embellish the fact that the two toy tops are approaching each other, thereby increasing the enjoyment of playing with toy tops.

According to the fifth aspect, the different effect displays can be displayed corresponding to the plurality of toy tops, making it easier to distinguish between each toy top and improving decorativeness, thereby increasing the enjoyment of playing with toy tops.

According to the sixth aspect, the motion state of the toy top can be reliably captured by the identification marker.

According to the seventh aspect, the different motion states can be captured using the identifiers, so that each of the motion state of the toy top can be reliably captured.

According to the eighth aspect, the field includes the front surface side on which the toy top can move and transmits light therethrough and the display means displays the image from the back side of the field, so that the display can be displayed in areas that are shaded by the toy top or other components that are located above the field, and can also be displayed in positions close to the toy top, thereby increasing the enjoyment of playing with the toy top.

According to the ninth aspect, the field is configured to scatter part of the light that passes through the field, and the display means projects the image onto the back surface side of the field using the projection device that projects the image, so that the field serves as a screen and a clear display can be displayed, thereby increasing the enjoyment of playing with the toy top.

### POSSIBILITY OF INDUSTRIAL APPLICABILITY

The game device according to the present disclosure can be suitably used in the fields of games using toy tops and the manufacture of game devices.

1. A game device comprising:
a field on which a toy top moves while spinning;
a display means being configured to display a first image on the field;
a capturing means being configured to capture motion of the toy top present on the field; and
a control means being configured to control the display means and the capturing means,
the control means being configured to detect a motion state of the top toy including a current position, a movement state, and a rotation state of the toy top, based on information from the capturing means;
the control means being configured to display the first image on the field corresponding to the motion of the toy top and to modify the first image according to the motion state, the first image including a second image;
the control means being configured to display the second image indicating a current position of the toy top on the field top.

2. The game device according to claim 1, wherein
the first image including a third image
the control means is configured to store information of the current position of the toy top over time for at least a predetermined period of time and to display the third image indicating a trajectory of movement of the toy top on the field.

3. The game device according to claim 1, wherein
the first image including a fourth image,
the control means is configured to display, when the toy top approaches a predetermined position on the field, the fourth image indicating that the toy top has approached the predetermined position, on the field corresponding to the current position of the toy top.

4. The game device according to claim 1, wherein
the first image including a fifth image,
the control means is configured to display. when a plurality of toy tops is present on the field, displaying, the fifth image in response to the top toy approaching a different top toy within a certain distance to each other, where the fifth image indicates that the top toy toys approach the different top toy within the certain distance to each other on the field corresponding to the current position of the top toy and a current position of the different top toy.

5. The game device according to claim 1, wherein
the first image including a sixth image,
the control means is configured to identify a second toy top and to display the sixth image corresponding to the second toy top.

6. The game device according to claim 1, wherein
the top toy includes an identification marker,
the capturing means is configured to capture the identification marker, and
the control means is configured to detect the motion state of the toy top based on a change over time in the identification marker captured by the capturing means.

7. The game device according to claim 6, wherein
the identification marker further includes
a first identifier that enables detection of the current position and the movement state of the toy top; and
a second identifier that enables detection of the rotation state of the toy top.

8. The game device according to claim 1, wherein
the field includes a front surface side on which the toy top moves, and lets light pass through, and
the display means is configured to display the first image on the field from a back surface side being opposite to the front surface side of the field.

9. The game device according to claim 8, wherein
the field is configured to scatter part of the light passing through the field, and
the display means includes a projection device being configured to project the first image, on the field from the back surface side of the field.
